(19) United States
(12) Patent Application Publication
(10) Pub. No.: US 2011/0137822 A1
(43) Pub. Date: Jun. 9, 2011

(54) COMPUTER-IMPLEMENTED PATTERN CHARTING

(76) Inventor: Gerald E. Chapman, Medina, OH (US)

(21) Appl. No.: 12/955,562

(22) Filed: Nov. 29, 2010

Related U.S. Application Data
(63) Continuation-in-part of application No. 12/341,634, filed on Dec. 22, 2008, now Pat. No. 7,844,487.
(60) Provisional application No. 61/015,673, filed on Dec. 21, 2007.
(60) Provisional application No. 61/015,674, filed on Dec. 21, 2007.
(60) Provisional application No. 61/015,675, filed on Dec. 21, 2007.

(51) Int. Cl. G06Q 40/00

(52) U.S. Cl. 705/36 R

(57) ABSTRACT

A method of transforming the standard O.H.L.C. (open, high, low, close) bar chart into a new advanced chart that diagrams value changes occurring within the charted period, disclosing the sequence of occurrence of value extremes (highest price or value compared to lowest price or value) as well as the direction and momentum of value changes during the ending portion of the period.

### CROSS-REFERENCE TO RELATED APPLICATIONS

This patent application claims priority to three provisional patent applications having respective Ser. Nos. 61/015,673; 61/015,674; 61/015,675; all of which were filed on Dec. 21, 2007. The subject matter of provisional patent applications having Ser. Nos. 61/015,673; 61/015,674; 61/015,675; all of which were filed on Dec. 21, 2007 are hereby incorporated into this application by reference.

### BACKGROUND OF THE INVENTION

Technical analysis is a technique that can be used to attempt to forecast the future direction of security prices or values through the study of past pricing patterns, primarily by the use of price and volume charts. The technical analysis industry is positively exploding Search engines list tens of thousands of web sites devoted to technical analysis.

Non-limiting examples of methods for performing technical analysis include open, high, low, close (O.H.L.C.) bar charts and candlestick charting. Regarding O.H.L.C. bar charts, the designation of the traditional bar chart, O.H.L.C., itself creates an assumption of intra-period movement, but the importance of intra-period patterns are not recognized or addressed in the traditional charting methods. Each bar represents a period of time within a graph that illustrates price intervals vertically and time intervals horizontally (See FIG. 1). Time periods most commonly represented are for trading days but they can be for any period such as a week or month. Day traders even use bar charts based on individual minutes.

The bar itself consists of a vertical axis representing the range of price for the period covered. A horizontal dash projects from the left side of the vertical axis at the price level in effect at the start of the period. Another horizontal dash projects from the right side of the axis to illustrate the closing price for the period.

In addition to revealing the opening, closing, high, and low prices for the period the bar chart tells us the range of price movement and whether the price was up or down for the period. By comparing several bars in a series we can determine price trends, price volatility, and any developing price patterns. Normally a second set of verticals is located below the price graph to indicate sales volume with taller bars representing higher volume.

Regarding candlestick charting, since the latter part of the nineteenth century far-eastern traders have used candlesticks for charting markets and for analysis based on trends in market psychology. Recently introduced to the western world they have steadily gained in popularity here in the last two decades. Candlestick charting provides the same information as bar charting but in a different format. The candlestick consists of a rectangular body, the height of which represents the differences between the periods opening price and the periods closing price. A centerline projecting from the top of the rectangle extends upward to the period's high. A similar centerline extends from the bottom to the period's low. The candlestick is colored to indicate whether the price increased or decreased during the period covered. Down periods are usually colored black or red while up periods are usually colored white or green (See FIG. 2). An advantage to candlesticks over bar charts is the rapid recognition of direction within a period due to the color of the rectangular body or “candle”. The shape of the body (depth verses width) along with the length of its top and bottom centerlines known as tails or shadows creates a unique configuration for each individual candlestick. In fact a whole area of technical analysis centers on the shapes of individual candlesticks.

### BRIEF SUMMARY OF THE INVENTION

The invention is directed to systems and methods for charting values or prices, and is suitable for the charting of financial securities and derivatives, or information related to such financial securities and derivatives. The invention presents an advancement to the traditional O.H.L.C. bar charting methods, and in one aspect is directed to a method of transforming a standard O.H.L.C. (open, high, low, close) bar chart that covers price or value changes within specific periods based on time or transaction quantities into a more inclusive chart that diagrams the pattern of those price or value changes by disclosing the sequence of price or value extremes (highest price or value compared to lowest price or value) as well as the direction and momentum of price or value changes during an ending portion of the period. The traditional O.H.L.C. bar charting methods reveals pricing data by the use of charting elements within a graph, where values are displayed vertically in the left or right margin, and time periods as represented by the charting elements are displayed horizontally at the top or bottom of the graph. Software creates each individual bar charting element by recording the opening price for the period, the highest price during the period, the lowest price during the period and the price at the end of the period. It visually exhibits the price range for the period by the display of a vertical line on the graph, with the opening price shown as a horizontal line extending from the left side of the vertical line, and a closing price with a second horizontal line extending from the right side of the vertical line. This arrangement is generally shown in FIG. 1. In this way O.H.L.C. software displays the pricing extremes that occur during the period, but does not indicate which of the extremes occurred first, and which of the extremes occurred last. Another shortcoming of the traditional O.H.L.C. bar charting software is that while it displays the price level at the close of the period, and its relationship to the high and low for the period, it in no way indicates whether the price was ascending or descending at the periods close. The present invention provides systems and methods, software programs and methods for recording and displaying all of the pricing information that the traditional O.H.L.C. bar charting software does, but adding valuable additional pricing data by indicating the sequence of occurrence for the periods highest price and the periods lowest price, as well as the pricing behavior during a closing period within the period represented by the chart. The invention provides this price sequencing data by recording each price during the period and comparing it to every other price during the period, to determine whether it is the highest price occurring up to the moment or the lowest price occurring up to the moment. The time of such occurrences are noted, and during an ending period within a charted period, the invention provides the timing of the high and low price extremes to determine the sequence of these events and record that sequence by placing a unique marking at or near the end of the chart vertical axis, representing the first price extreme, or by placing a unique marking at or near the end of the vertical, representing the last price extreme, or by marking both extremes with uniquely different markings. The invention provides valuable data indicating the direction of price movement along with the momentum of price movement just prior to the periods close, by recording the price level at a predetermined interval prior to the end of the period, and using unique markings as an indicator of price or value level at the beginning of this predetermined interval, which may be referred to as the closing frame. Thus, if the closing frame indicator appears below the closing price, it indicates that the price was rising at the periods close. Similarly, if the closing price or value indicator is below the closing line to such a degree that the price was rising with great momentum at the periods close, this also will be indicated. Conversely, if the closing frame indicator is above the closing line, this indicates the price was falling at the periods close. Similarly, if the closing frame indicator is well above the closing line, this indicates the price was falling rapidly at the periods close, indicating this negative momentum at the periods close. These closing frame price or value indicators and analysis provides very valuable information for a trader, and is useful for day trading, after hours trading, tick trading and Forex trading, where one period feeds directly into the next, so that the closing price direction from one period to the next will become the starting price direction for the next period.

The invention is a computer implemented charting method that can be used to chart the price or value movement of financial instruments. Nonlimiting examples of such financial instruments include: securities, commodities, derivatives, ticks and Forex, all such financial instruments being collectively referred to herein as securities. The invention embodiments cover a predetermined period of time and provide intra-period pricing pattern data. The data provided includes all the data shown by traditional O.H.L.C. bar charts and candlestick charts such as opening price or value, closing price or value, and range of price or value during the period coveted but also includes valuable additional pattern recognition such as the sequence of price or value extremes along with end-of-period price or value direction and momentum. The invention in one of its embodiments can also provide instant pattern recognition by the ability to color or shade chart elements, with much more data being conveyed to the user.

The additional intra-period pattern insight as provided by the invention is helpful to the user, since every facet of additional information can be utilized to determine its role, if any, in predicting future price or value movement, which is a commonly known purpose of technical analysis. The invention incorporates the traditional O.H.L.C. bar chart with added display elements that are not known in conventional O.H.L.C. bar charting or even in candlestick charting, and make the invention a much more advanced charting tool.

Embodiments of the invention may involve uniquely important factors for intra-period pattern recognition. They include: 1) recognition of the sequence of price or value changes by indicating which price or value extreme for the data period first occurred; 2) recognition of price or value direction and momentum toward the end of the data periods close; 3) coloring or shading to indicate price or value direction; 4) dual coloring or shading; and 5) volume of activity recognition.

Overall the ideas embodied in the invention provide instant intra-period pattern recognition for making better predictions of future inter-period patterns. Such pattern recognition should result in far better back testing of market trading ideas by making more visible the relationship between intra-period and the resulting inter-period movements.

Embodiments of the invention offers insight into intra-period patterns of movement by showing the sequence of the major moves. No other charting method does that.

By viewing a series of the invention elements, intra-period tendencies can be determined such as whether the charted entity tends to fade early then bounce back or if it tends to rally early then drop. Such sequential tendencies can be analyzed for inter-period pattern and trend determination and changes in inter-period patterns or trends that might indicate a future change in course.

The invention also gives insight into the actual amount, direction, and speed or momentum with which the charted subject entity gains or losses in the final moments of the period charted, also known as its closing momentum and direction. This is another feature that is not available in other charting methods even though this can prove to be helpful information for Forex and day traders. Unlike time periods in daily charts, each time period used in day trading and Forex feeds into the next so that the closing direction of one period should be the opening direction of the next.

The greater insight provided into closing moments momentum could provide a much better insight into intra-period volatility. During stressful times markets tend to display greater volatility.

By viewing a series of the invention elements, closing momentum tendencies may be revealed including: (A) ratio of upward to downward closings; (B) specific inter-period closing trends and patterns; and (C) any changes in inter-period patterns that might indicate a future change in course.

Because the invention embodiments have one or two enclosed triangular areas which can be colored or shaded, such coloring or shading can provide a quick visual review of the number of down periods as compared to the number of up periods. Shading or coloring can also provide a quicker visual review of inter-period patterns and trends based on how the shades or colors are distributed from period to period. Shading or coloring can also provide a rapid recognition of any important changes in pattern or trend that could foretell future changes in direction.

In an invention embodiment, when only the sequential triangle on the left of the charting element is shaded or colored to indicate the period's overall direction and the closing direction/momentum triangle on the right of the charting element is shaded or colored according to the direction of movement, up or down, during the closing moments, then a quick visual realization of both the periods overall and closing movements can be created.

As is the case of the overall period's price or value movement, shading or coloring can also provide quick recognition of inter-period ratios, patterns, and trends as they pertain to intra-period closing moments. Here again, pattern or trend changes might foretell future direction. While shading or coloring may create a better display in pattern charting it is not mandatory as it is in candlestick charting.

Price or value movements made at above average volumes are generally considered more important than lower volume moves. In most financial charting vertical volume bars are shown below the price or value chart giving a good idea of the actual volume but not how it compares to the average. Several embodiments in the invention charting will permit the recognition of volume that is near average or above or below average by lengthening or shortening the horizontal lines representing the periods opening or close, or otherwise indicating such information. Longer horizontal lines will indicate higher volume while shorter lines will represent lower volume. In fact, the opening horizontal line can be used to indicate volume range for the entire period while the closing line can be used to indicate volume status during closing. High closing volume may indicate a rush to buy or a rush to sell. This is the kind of information a trader should know but the periods closing volume is unavailable in O.H.L.C. bar charting and in candlestick charting.

A whole field of technical analysis expertise has grown around candlestick groupings. The same type of element grouping analysis can be applied using the invention in place of candlesticks. Compared to candlestick charting, the invention has several pattern charting elements for each candlestick and the invention elements contain more data so the number of groupings to analyze would increase and due to superior data the forecasting reliability should increase as well.

Candlestick analysis is also based on individual candlestick shapes that are given names such as Doji, Dragonfly Doji, Gravestone Doji, Hanging Man, Hammer, etc. with analysis built around each shape. While there are actually only nine basic candlestick shapes there are an infinite number of different shaped representations according to the present invention. There are basically three hundred and ninety six distinct icons when allowing two closing momentum possibilities—full (from the period's price or value extreme to the closing level) or half that amount as illustrated in FIG. 10 and nine volume configurations as illustrated in FIG. 11. The invention provides increased technical analysis possibilities.

The pattern recognition incorporated in the invention will result in much easier back testing of market trading ideas. In periods where the opening value and closing value are close the direction of movement can be difficult to discern in other charting systems but not in the invention because the triangles normally provide space for shading or coloring that will easily indicate the direction of movement.

### BRIEF DESCRIPTION OF THE SEVERAL VIEWS OF THE DRAWING

FIG. 1 illustrates an embodiment of known O.H.L.C. Bar Charting.

FIG. 2 illustrates an embodiment of known Candlesticks.

FIG. 3 illustrates an embodiment of the invention.

FIG. 4 illustrates an embodiment of the invention.

FIG. 5 illustrates an embodiment of the invention.

FIG. 6 illustrates an embodiment of the invention.

FIG. 7 illustrates an embodiment of the invention.

FIG. 8 illustrates an embodiment of the invention.

FIG. 9 illustrates an embodiment of the invention.

FIG. 10 illustrates embodiments of the invention.

FIG. 11 illustrates embodiments of the invention.

FIG. 12 illustrates an embodiment of the invention.

FIG. 13 illustrates an embodiment of the invention.

FIG. 14 illustrates an embodiment of the invention.

FIG. 15 illustrates an embodiment of the invention.

FIG. 16 illustrates an embodiment of the invention.

FIG. 17 illustrates an embodiment of the invention.

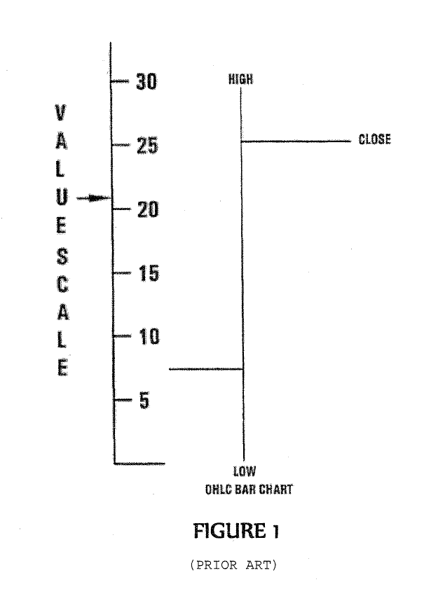

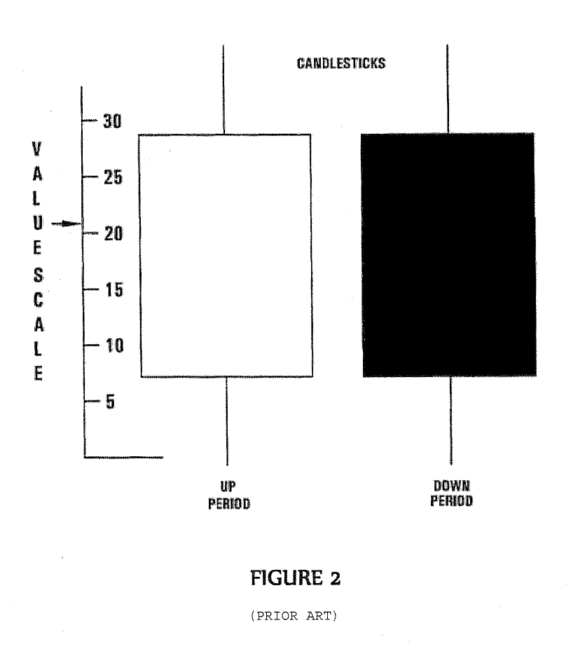

### DETAILED DESCRIPTION OF THE INVENTION

Generally disclosed are embodiments directed to pattern-charting methods. At least one embodiment is directed to using a computer to execute the electronic transformation of data into a visual depiction of a pattern created by the data. Another embodiment is directed to at least one pattern-charting method that can be used to display patterns created by a publicly traded instrument or security during the course of trading throughout a particular trading period.

Pattern charting embodiments provide for using i) five in combination with ii) a value scale, and iii) optional shading or coloring, in order to display opening and closing prices or values, upper and lower market extremes, an indication of the first market extreme, the direction of data or price or value movement during a predefined closing frame, and volume of activity.

Market extremes are the greatest and least values of data points during a particular period.

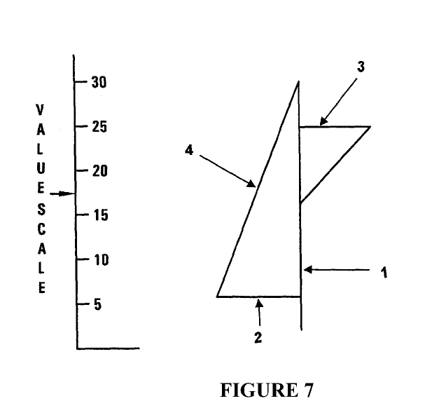

With reference to FIG. 7, and as a non-limiting example, the upper tip of vertical line 1 represents the upper market extreme for a particular time period. The value of the upper market extreme can be determined based upon the position of the upper tip of vertical line 1 relative to the value scale shown on the left side of FIG. 7. With reference to FIG. 7, the upper market extreme is approximately 30.

With reference to FIG. 7, and as a nonlimiting example, the lower tip of vertical line 1 represents the lower market extreme for a particular time period. The value of the lower market extreme can be determined based upon the position of the lower tip of vertical line 1 relative to the value scale shown on the left side of FIG. 7. With reference to FIG. 7, the lower market extreme is approximately 2.

The length of vertical line 1 will vary depending on the differential between the upper and lower extreme, and persons of ordinary skill in the art will appreciate this. With reference to FIG. 7, the length of vertical line 1 is approximately 28 (units) relative to the value scale shown on the left side of FIG. 7.

The first market extreme is the first extreme to occur during a particular time period or data period, and the second market extreme is the second extreme to occur during a particular time period or data period.

An opening price or value or opening data point can be understood as the first price or value or first data point of the time period that is being measured. As a non-limiting example, in the field of securities trading, the opening price or value or opening data point is the actual price or value of the security just prior to and at the very opening of trading for a particular period.

With reference to FIG. 7, and as a nonlimiting example, horizontal line 2 represents the opening price or value or opening data point for a particular time period. The value of the opening price or value or opening data point can be determined based upon the position of horizontal line 2 relative to the value scale shown on the left side of FIG. 7. With reference to FIG. 7, the opening price or value is approximately 6.

In those embodiments directed to security trading, an additional embodiment is directed to horizontal line 2 having variable length, in order to visually indicate the volume of trading for a trading period. An embodiment provides for relatively shorter lengths indicating relatively low amounts of trading, and relatively longer lengths indicating relatively greater amounts of trading.

A closing price or value or closing data point can be understood as the last price or value or last data point of the time period that is being measured. As a non-limiting example, in the field of securities trading, the closing price or value or closing data point is the actual price or value of the security at the end of trading for a particular day or particular period.

With reference to FIG. 7, and as a nonlimiting example, horizontal line 3 represents the closing price or value or closing data point for a particular time period. The value of the closing price or value or closing data point can be determined based upon the position of horizontal line 3 relative to the value scale shown on the left side of FIG. 7. With reference to FIG. 7, the closing price or value is approximately 25.

In those embodiments directed to security trading, an additional embodiment is directed to horizontal line 3 having variable length, in order to visually indicate the volume of trading for a trading period. An embodiment provides for relatively shorter lengths indicating relatively low amounts of trading, and relatively longer lengths indicating relatively greater amounts of trading.

In other embodiments, the respective lengths of horizontal line 2 and horizontal line 3 may be directed to describing the volume of trading for distinct time frames or trading periods. In other words, the length of horizontal line 2 may be directed to describing the volume of trading for a first data frame or time period, and the length of horizontal line 3 may be directed to describing the volume of trading for a second data frame or time period.

A data period can be understood as a time period during which data is collected. A nonlimiting example of a data period is the trading period of a security.

In accordance with examples of the invention, the closing frame will start at any desired predetermined data point within a given period, and which will be toward the end of such period. Normally the starting point chosen for the closing timeframe may be that which is most appropriate for the securities or properties being analyzed.

The closing frame may be designated as a percentage of the period being charted or as a specific data period.

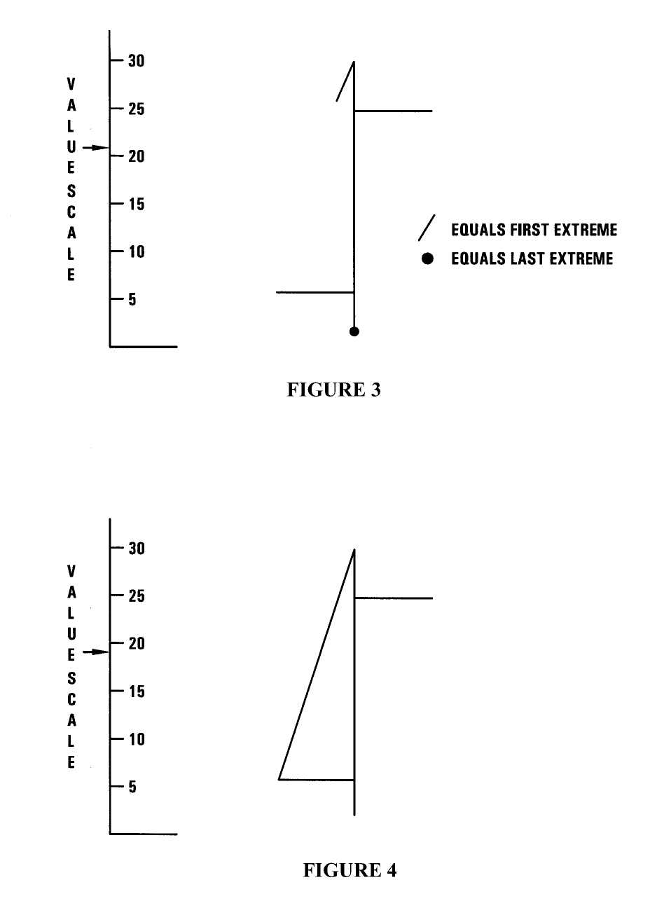

With reference to FIG. 3, embodiments of the invention place a visual indicator at the top or bottom of the vertical line or price or value bar in order to designate the sequence, i.e. first, last, or both first and last, of extremes for the data period. If desired, both extremes can marked with different visual indicators. As illustrated in FIG. 3, a dot or ball on one of the tips of the vertical line can be used to visually indicate the second or last extreme value for the data period. FIG. 3 also illustrates that a diagonal line in contact with a tip of the vertical line can be used to indicate the first extreme of the data period. This identification of extreme price or value sequencing will tell the analyst or trader at a glance whether the first price or value extreme was the high or the low for the period. With this information the analyst or trader can ascertain whether the intra-period pattern was one of rising after opening, then dropping or if was one of dropping after opening only to rise again prior to close. In embodiments, a series of such pattern charting elements having such encoded sequential data will illustrate to the technical analyst whether a security tends to fade early only to bounce back or if it tends to rally early only to fade towards the close of each period. Such information is of obvious value when attempting to assess future price or value movements.

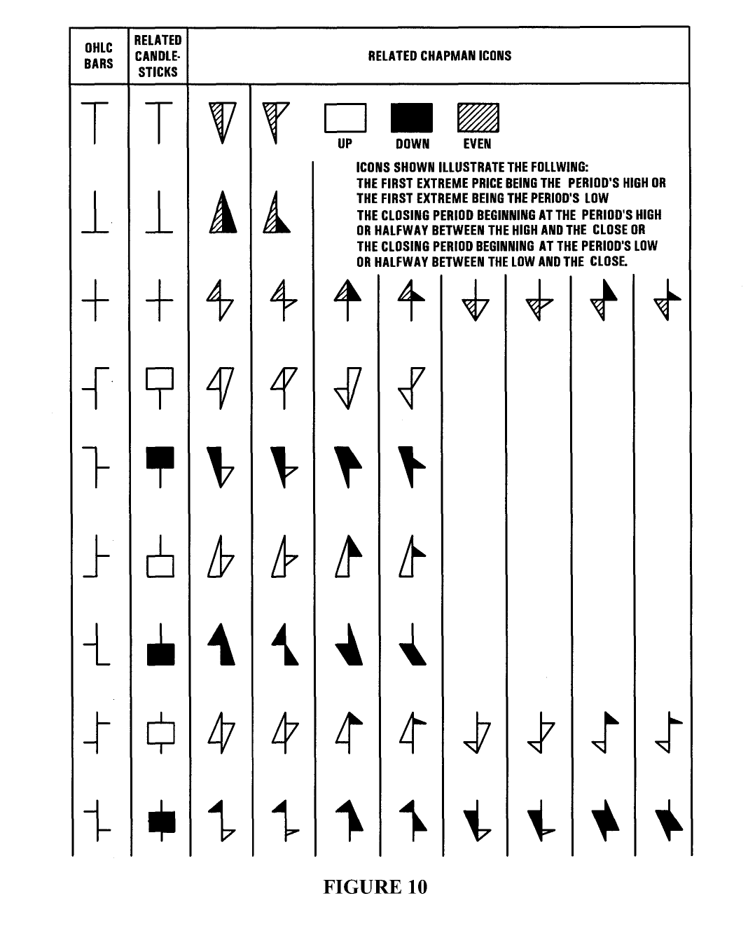

A pricing or value sequence can best be illustrated by programming software to place an identifying mark at or near the end of the chart vertical representation, which is a representation of the first price or value extreme. With the first price or value extreme marked, the last value extreme may then be represented by the unmarked end of the bar chart vertical. In an example, the way in which the invention marks the first price or value extreme may be with a diagonal line extending from the appropriate bar chart vertical position or end to the outer edge of the horizontal line representing the periods opening price or value. In this manner, a visual concept of the initial price movement is created, by illustrating a path from the open price or value to the first occurring extreme price for the period. Unless the periods open price or value is the periods high or the periods low, this procedure also creates a triangular pattern on the left side of the charting element which can be categorized for analysis according to its height versus its width, with a long triangle illustrating a large price movement away from the initial opening price, such as shown in FIG. 4. Likewise, the periods closing frame price or value movement may be illustrated by an embodiment of creating a second diagonal line emanating from the right side of the bar chart's vertical at the price or value in effect at the predetermined data point initiating the start of a selected closing frame, and extending to the outer end of the horizontal line representing the periods close. Unless the price at the beginning of the closing frame is the same as the periods closing price, this will create a second triangular pattern on the right side of the charting element, which can also be categorized for shape analysis with a long triangle illustrating a large amount of closing price change momentum, such as shown in FIG. 6. In such embodiments, there is created a unique shape for each charting element which quickly visually illustrates an intra-period pricing or value pattern, creating a special shape or icon for use in technical analysis, with further examples shown in FIG. 7. Technical analysis based upon the shapes of the created representations, provide enhanced technical analysis based upon revealing much more data concerning intra-period patterns. It should also be recognized that the various icon shapes producible according to the invention may widely vary, and each may convey and communicate valuable information to a trader or other user, with reference to FIG. 10. As illustrated in FIG. 4, an embodiment for indicating the first price or value extreme uses a diagonal-line indicator that extends from a tip of the opening-price or value horizontal line (i.e., the tip of the horizontal line that does not intersect with the vertical line) to the tip of the vertical line that represents the first price or value extreme. In FIG. 7, the first price or value extreme is illustrated using line 4.

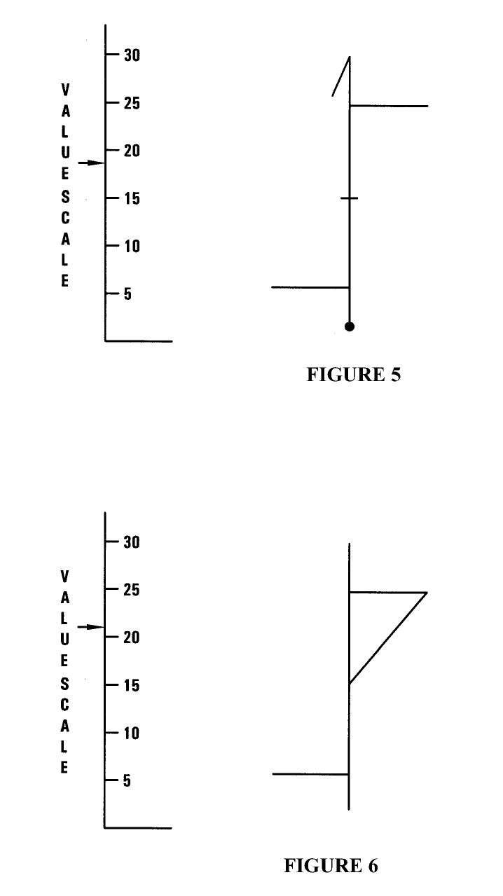

Embodiments are directed to displaying value or price direction and momentum during the periods closing moments. This can be accomplished by placing a unique marking on the vertical axis of the price or value bar at the price or value occurring at a predetermined point prior to closing--such as the last hour or half hour of the trading day if a trading day is the period in question, the last 10%, or a final percentage of the period covered; FIG. 5 illustrates such a marking. Traditional bar charts as well as candlesticks tell where the price or value has gone during the period but fail to tell how it was moving at period's end. Knowledge of the ending price or value momentum and particularly direction is invaluable especially in such areas as Forex or day trading where one period feeds directly into the next. For these traders, this aspect alone gives them an edge in determining market direction that was totally unavailable to them before. Other traders and analysts can review a series of periods containing closing directional momentum data and derive a sense of ratios, trends, patterns, and pattern changes, which may help foretell the future course of prices or values.

As illustrated in FIG. 6, an embodiment for displaying the pricing momentum during a closing frame involves identifying the appropriate point on the vertical axis that indicates the value of a security or data point at the beginning of the closing frame and then extending a diagonal line from that point on the vertical axis to a tip of the closing-price or value horizontal-line indicator. In an embodiment, and as can be seen in FIG. 6, a result of using a diagonal line to display the pricing momentum during a closing frame is that a substantially enclosed right triangle is formed.

With further regard to FIG. 6, the relatively upward or downward slope of the diagonal line provides a readily visible indication of both the direction and extent or momentum of the period's final price or value movement.

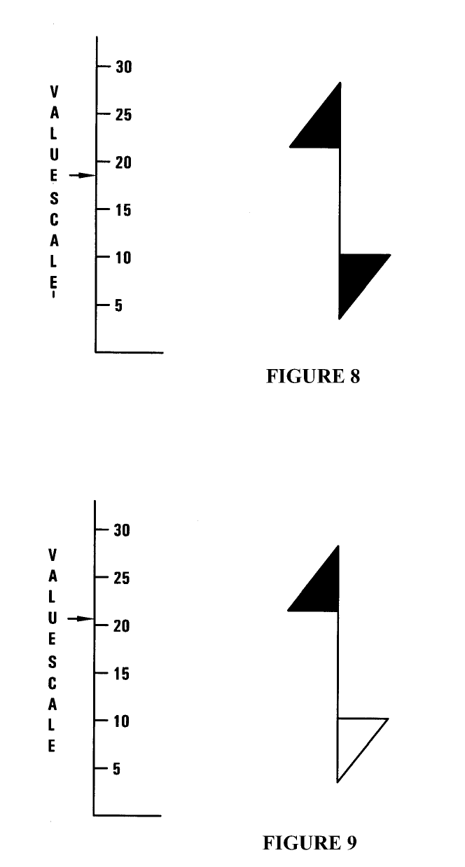

Embodiments provide for using coloring or shading to indicate price or value direction. The diagonals utilized in some of the embodiments create triangular enclosures that can be colored or shaded to give instant visual recognition to the intra-period's overall price or value-direction movement. When viewing a series of data periods, this will highlight the ratio of upward to downward closings and any related inter-period patterns as they develop. Unlike candlesticks however coloring or shading is not required to distinguish the opening from the closing or to show the direction of the period's move. Also unlike candlesticks where when opening price or value and closing are the same there is no body formed, pattern charts may still have areas, e.g., triangular, to color or shade. In fact, a third color or shade can be utilized to indicate even periods where opening and closing are the same or nearly so. Nonlimiting examples of coloring embodiments include green for up, red for down, and gray or white for even. Additional shading embodiments include white for up, black for down, and gray for even. Embodiments allow for any combination of colors to be used. FIGS. 8 and 9 provide nonlimiting examples of useful shading embodiments. FIG. 8 is directed to an embodiment with shaded triangular areas in order to indicate an overall down period.

Referring to FIG. 9 another shading embodiment uses dual coloring or shading. In this embodiment the left sequential triangle is colored or shaded in accordance with the overall period price or value direction but the right triangle which designates the price or value direction during the closing frame is colored or shaded in accordance with that price or value direction. In this way both the total and final price or value directions will be obvious at a glance.

Referring to FIG. 7, still another shading embodiment uses non-shaded triangular areas to indicate both an overall upward period as well as an upward momentum price or value direction during the closing frame.

FIG. 10 illustrates non-limiting examples of pattern charting embodiments in relative comparison to candlestick charting and O.H.L.C. bar charting.

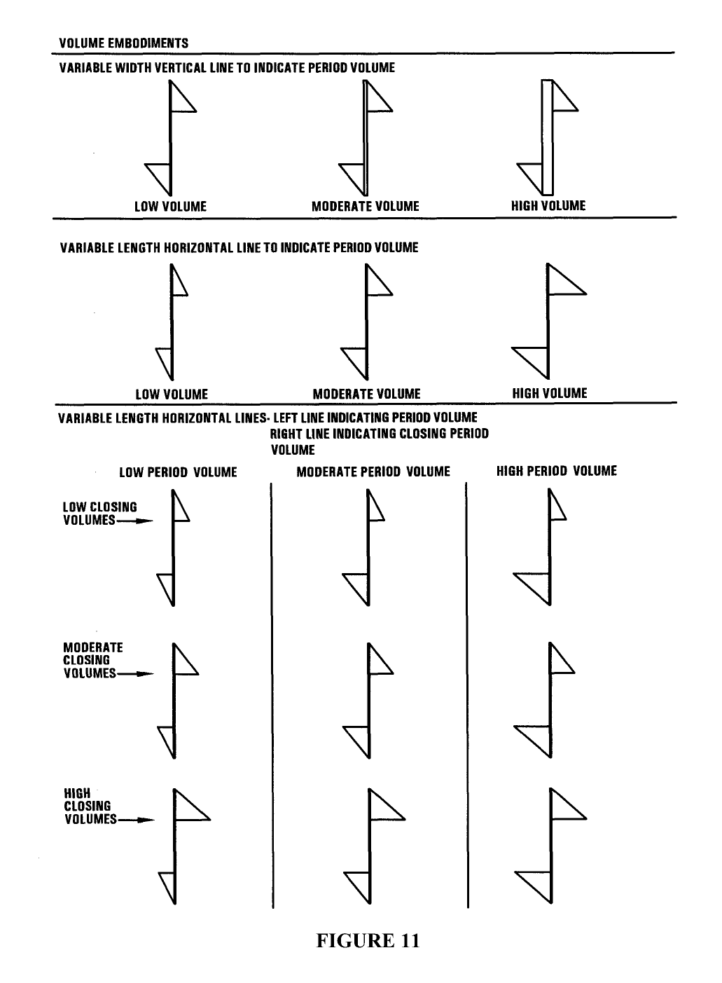

FIG. 11 illustrates various volume embodiments.

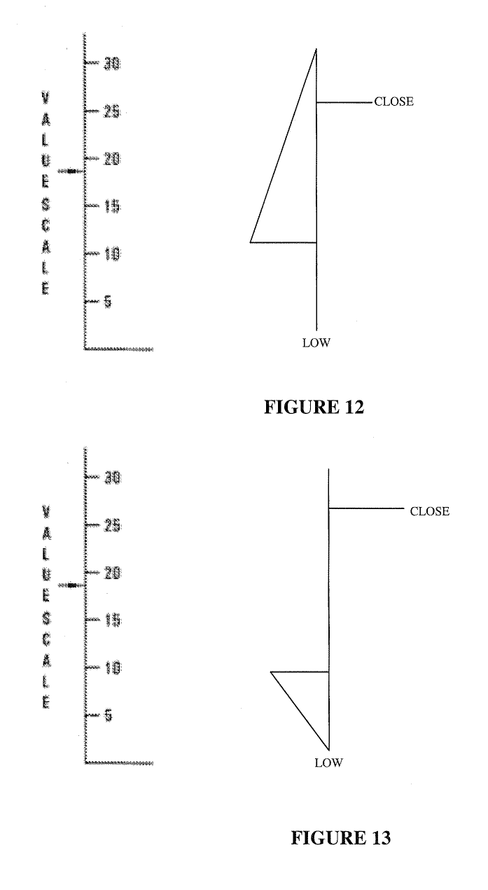

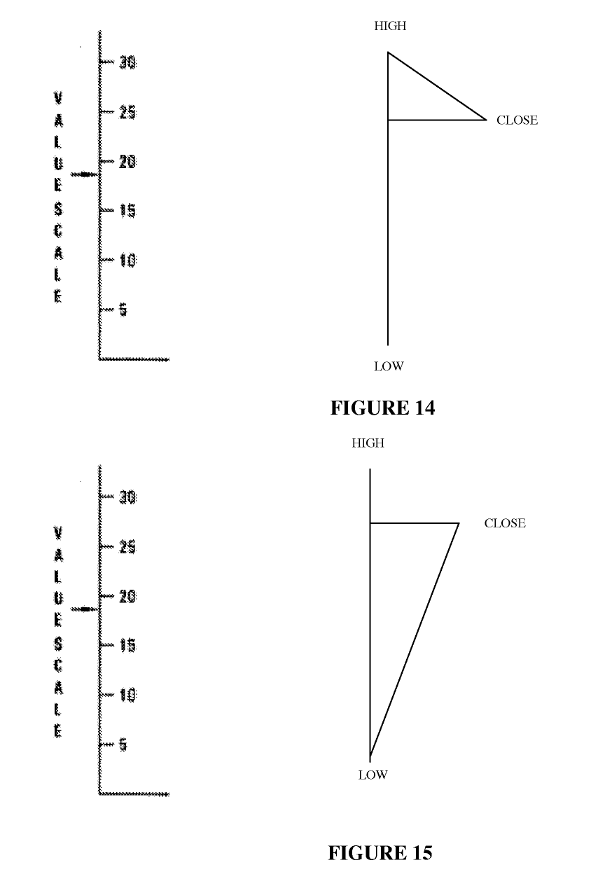

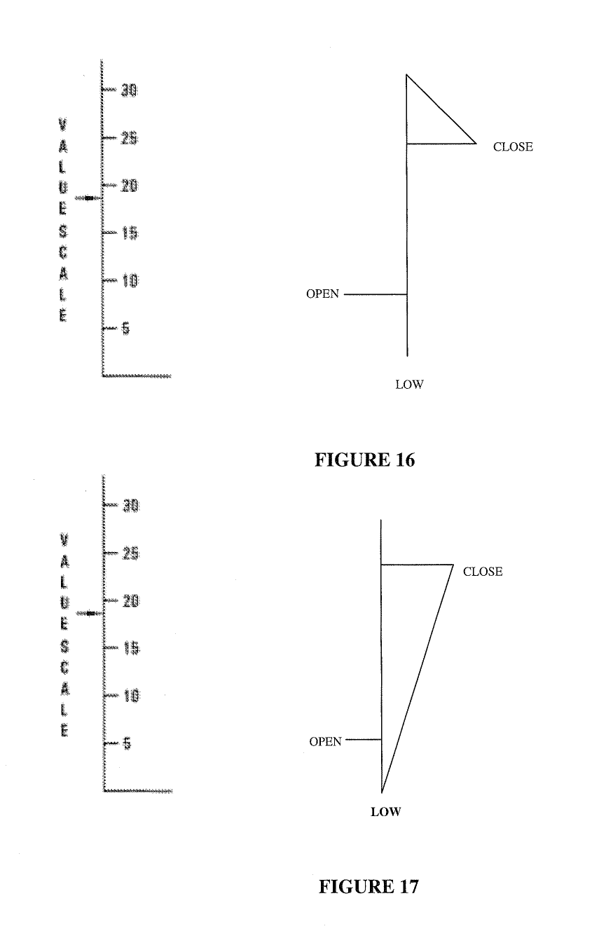

Turning now to FIGS. 12 and 13, there are shown further examples according to the invention. As illustrated in FIG. 12, an embodiment for displaying the O.H.L.C. information, and indicating the first extreme price or value of the charting period was the highest price or value via the left hand triangle, and showing the close for the charting period via the marking extending from the right of the axis. Similarly, FIG. 13 shows the first extreme for the charting period was the lowest price or value via the left hand triangle, and shows the close for the charting period via the marking extending from the right of the axis. Other examples are shown in FIGS. 14-17, providing HLC information. FIG. 14 shows the direction of price or value change during a closing period or time frame by identifying the appropriate point on the vertical axis that indicates the value of a security or data point at the beginning of the closing frame, and then extending a diagonal line from that point on the vertical axis to a tip of the closing-price or value horizontal-line indicator, forming the right hand triangle. This chart indicates a down direction for the closing period. Other indicators showing such information may be used in any of the invention embodiments. In FIG. 15, the chart shows the direction of price or value change during a closing period or time frame by identifying the appropriate point on the vertical axis that indicates the value of a security or data point at the beginning of the closing frame, and then extending a diagonal line from that point on the vertical axis to a tip of the closing-price or value horizontal-line indicator, forming the right hand triangle. This chart indicates a up direction for the closing period. This chart also may show the open price or value via the marking extending from the left of the axis. In FIG. 16, the chart shows the direction of price or value change during a closing period or time frame by the right hand triangle, showing a down direction for the closing period. This chart also may show the open price or value via the marking extending from the left of the axis. In FIG. 17, the chart shows the direction of price or value change during a closing period or time frame by the right hand triangle, indicating an up direction for the closing period. This chart also may show the open price or value via the marking extending from the left of the axis. In addition, it should also be understood that the invention may be used to chart information relative to tick charting techniques, where the number of transactions is used as reference rather than time. The same techniques as described may be used to chart information relative to tick information accordingly.

While the invention has been illustrated and described in detail in the foregoing drawings and description, the same is to be considered as illustrative and not restrictive in character, it being understood that only illustrative embodiments thereof have been shown and described, and that all changes and modifications that come within the spirit of the invention described by the following claims are desired to be protected. Additional features of the invention will become apparent to those skilled in the art upon consideration of the description. Modifications may be made without departing from the spirit and scope of the invention.

What is claimed is:

1. A method of transforming a standard O.H.L.C. (open, high, low, close) bar chart that covers price or value changes within specific periods based on time or transaction quantities into a more inclusive chart that diagrams the pattern of those price or value changes by disclosing the sequence of price or value extremes (highest price or value compared to lowest price or value) as well as the direction and momentum of price or value changes during an ending portion of the period, comprised of using non-transitory computer-readable media having computer-readable instructions thereon executing, by a computer the following steps;
developing a control data that identify pre-defined periods based on time or transaction quantities including period openings, intra-period closing frame segments and period closings,
receiving source of market price or value data for a charted entity,
interfacing the control data with the source of market price or value data, converting the control data and the market price or value data into charting durations thereby establishing the charting period as well as an opening price or value a closing price or value, and the charting period's intermediary price or value data including an intra-period closing frame's initial price or value,
comparing of the charting period's price or value data to establish a final highest price or value occurring during the charted period, a final lowest price or value occurring during the charted period and a range of prices or values during the charted period,
determining a sequence of extreme prices or values during a charting period, highest verses lowest,
transforming of the opening price or value, closing price or value and the charting period's intermediary price or value data into a chart that defines the opening price or value, highest price or value, lowest price or value, initial closing frame price or value and closing price or value, as well as the sequence of price or value extremes, highest verses lowest, that will provide an indication of an intra-period pricing or value pattern, and will also indicate the initial closing frame price or value so that comparison of the price or value at the beginning of the intra-period closing frame to the charting period's closing price or value provides an indication of a direction of change in price or value during the intra-period closing frame, if any, as well as the degree and speed of change occurring,
presenting a charting period's activity in a chart comprising a graph having a vertical price or value scale and composed of a vertical axis having a length, where the length and positioning in relation to the vertical price or value scale demonstrates the charting period's price or value range and a horizontal line extending leftwardly from the vertical axis demonstrating the charting period's opening price or value by its level of positioning in relation to the price or value scale and a horizontal line extending rightwardly from the vertical axis demonstrating the charting period's closing price or value by its level of positioning in relation to the price or value scale,
the chart also graphically illustrating the sequence of the occurrence of the price or value extremes, highest or lowest, by displaying an identifying mark on or near the top of the chart's vertical axis if the period's highest price or value occurs first or by displaying an identifying mark on or near the bottom of the chart's vertical axis if the period's lowest price or value occurs first or by displaying uniquely different identifying marks, a first unique mark identifying the first occurring extreme price or value, high or low, and placed on or near the corresponding end, top or bottom, of the vertical axis and a second unique mark identifying a charting period's last extreme price or value placed on or near the opposite end of the vertical axis, and
transforming the market price or value data to graphically illustrate an identification of the initial price or value of the pre-selected intra-period closing frame by displaying an identifying mark on or near the chart's vertical axis at a level in relation to the price or value scale that correspond to the initial price or value of the intra-period closing frame.

2. The method of claim 1, whereby a graphic display of the sequence of occurrence of price or value extremes is provided by marking only the period's first occurring extreme price or value, with the other extreme price or value then being the period's last occurring extreme price or value and having the identifying mark for the first occurring extreme price or value be a diagonal line extending from the outside tip of the horizontal line that depicts the opening price or value and indicating a general intra-period price or value movement by extending to the top of the chart's vertical axis if the first extreme price or value is the period's highest price or value or by extending to the bottom of the chart's vertical axis if the first extreme is the period's lowest price or value thus creating a left side triangular pattern except where the opening price or value is the first extreme price or value.

3. The method of claim 1, whereby a graphic display of the initial price or value of the intra-period closing frame along with the price or value movement within the closing frame is provided by;
marking the vertical axis of the chart at a price or value level occurring at the beginning of the closing frame with a diagonal line that indicates intra-period closing frame price or value movement by extending upward to the outside tip of the horizontal line representing the period's closing price or value if the level of price or value is increasing during the closing frame or by extending downward to the outside tip of the horizontal line representing the period's closing price or value if the level of price or value is decreasing during the closing frame, thus illustrating a direction, degree, and speed of changes in price or values during the pre-selected intra-period closing frame as well as creating a right side triangular pattern except where there is no net change in price or value during the closing frame.

4. The method of claim 2, wherein the interior of the triangular pattern is shaded or colored for indicating a direction of changes in price or value for the charted period, up or down, as determined by comparison of the closing price or value data to the opening price or value data or a previous periods closing price of value data, and by selecting and generating specific shades or colors to indicate a direction of price or value movement, if any, with predetermined shades or colors representing upward price or value movement, predetermined shades or colors representing downward price or value movement and predetermined shades or colors representing no overall change in price or value.

5. The method of claim 3, wherein the interior of the triangular pattern is shaded or colored for indicating a direction of changes in price or value for the charted period, up or down, as determined by comparison of the closing price or value data to the opening price or value data and by selecting and generating specific shades or colors to indicate a direction of price or value movement, if any, with predetermined shades or colors representing upward price or value movement, predetermined shades or colors representing downward price or value movement and predetermined shades or colors representing no overall change in price or value.

6. The method of claim 3, wherein the interior of the triangular pattern is shaded or colored for indicating a direction of changes in price or value up or down, during that chart period representing the closing frame determined by comparison of the initial price or value data of the pre-selected closing frame to the closing price or value data or a previous periods closing price of value data and by selecting and generating predetermined shades or colors to indicate direction of any such change with a predetermined shade or color representing upward price or value movement and another predetermined shade or color representing downward price or value movement.

7. The method of claim 1, further comprising indicating volume of activity along with a pattern of price or value changes in the chart by performing the following steps;
defining a number and scope of volume ranges to be depicted for the charted entity,
receiving a secondary set of input data comprising market trading volume data simultaneously with the price or value data and interfaced with the same set of control data,
transforming the volume data input interfaced with the control data to calculate average volume for the charting period and categorize it by range based on defined volume ranges,
depicting the period's volume range by an increase or decrease of a length of the chart's left horizontal line, right horizontal line, or both, in increments representing specific volume ranges.

8. The method of claim 1, further comprising indicating an average volume range during the period's closing frame compared to the period's overall average volume range thereby providing further information regarding closing momentum by indicating whether volume levels are increasing, decreasing, or staying steady as the charting period is coming to a close by performing the following steps;
defining a number and scope of average volume ranges to be depicted for the charted entity,
receiving a secondary set of input data comprising market trading volume data simultaneously with the price or value data and interfaced with the same set of control data,
transforming the volume data interfaced with the control data to calculate average volume for the entire charted period and categorize it by range of volume based on defined volume ranges that are to be depicted and also calculate average volume for the closing frame and categorize it in a manner based upon the same volume ranges,
depicting the closing frame's volume range as compared to the entire period's volume range by an increase or decrease in length of the right horizontal closing price or value line in increments to reflect the closing frame's average volume range as well as to increase or decrease in length of the left horizontal opening price or value line to reflect the entire period's average volume ranges.

9. The method of claim 1, further comprising indicating whether average volume is increasing, decreasing, or staying steady as the charting period-closes by performing the following steps;
defining a number and scope of average volume ranges to be depicted for the charted entity,
receiving a secondary set of input data comprising market trading volume data simultaneously with the price or value data and interfaced with the same set of control data,
transforming the volume data interfaced with the control data to calculate average volume for the entire charted period and categorize it by range of volume based on defined volume ranges and also calculate average volume for the closing frame and categorize it in a same manner based upon the same volume ranges,
depicting the closing frame's volume range as compared to the entire period's volume range by providing a left horizontal opening price or value line of a predetermined length and with a right horizontal closing price or value line of an equal length only when the closing frame average volume is within the same defined average volume range as the overall period's defined average volume range but increasing a length of the right horizontal closing price or value line by one increment for each additional average volume range that the closing frame exceeds that of the overall period and decreasing the length of the horizontal closing price or value line by one increment for each volume range that the closing frame's volume is lower than that of the average range for the overall period.

10. A method of claim 1, whereby any financial assets or securities including stocks, commodities, Forex, and/or derivative of any of the aforementioned categories or any suitable non-financial entities which have a series of varying values can be segregated into time or data periods are charted.

11. A method of transforming a standard O.H.L.C. (open, high, low, close) bar chart that covers price or value changes within specific periods based on time or transaction quantities, that diagrams the pattern of those price or value changes by disclosing the sequence of price or value extremes (highest price or value compared to lowest price or value), comprised of using non-transitory computer-readable media having computer-readable instructions thereon executing, by a computer the following steps;
developing a control data that identifies pre-defined periods based on time or transaction quantities including period openings and period closings;
receiving source of market price or value data for a charted entity,
interfacing the control data with the source of market price or value data, converting the control data and the market price or value data into charting durations thereby establishing the charting period as well as an opening price or value, a closing price or value, and the charting period's intermediary price or value data,
comparing of the charting period's price or value data to establish a final highest price or value occurring during the charted period, a final lowest price or value occurring during the charted period and a range of prices or values during the charted period,
determining a sequence of extreme prices or values during a charting period, highest verses lowest,
transforming of the opening price or value, closing price or value and the charting period's intermediary price or value data into a chart that defines the opening price or value, highest price or value, lowest price or value, and closing price or value, as well as the sequence of price or value extremes, highest verses lowest, that will provide an indication of an intra-period pricing or value pattern,
presenting a charting period's activity in a chart comprising of a graph having a vertical price or value scale and composed of a vertical axis having a length, where the length and positioning in relation to the vertical price or value scale demonstrates the charting period's price or value range and a horizontal line extending leftwardly from the vertical axis demonstrating the charting period's opening price or value by its level of positioning in relation to the price or value scale and a horizontal line extending rightwardly from the vertical axis demonstrating the charting period's closing price or value by its level of positioning in relation to the price or value scale with the chart being in black or colored to denote price or value movement and,
the chart also graphically illustrating the sequence of the occurrence of the price or value extremes, highest or lowest, by displaying an identifying mark on or near the top of the chart's vertical axis if the period's highest price or value occurs first or by displaying an identifying mark on or near the bottom of the chart's vertical axis if the period's lowest price or value occurs first or by displaying uniquely different identifying marks, a first unique mark identifying the first occurring extreme price or value, high or low, and placed on or near the corresponding end, top or bottom, of the vertical axis and a second unique mark identifying a charting period's last extreme price or value placed on or near the opposite end of the vertical axis.

12. The method of claim 11, whereby a graphic display of the sequence of occurrence of price or value extremes is provided by marking only the period's first occurring extreme price or value, with the other extreme price or value then being the period's last occurring extreme price or value and having the identifying mark for the first occurring extreme price or value be a diagonal line extending from the outside tip of the horizontal line that depicts the opening price or value and indicating a general intra-period price or value movement by extending to the top of the chart's vertical axis if the first extreme price or value is the period's highest price or value or by extending to the bottom of the chart's vertical axis if the first extreme is the period's lowest price or value thus creating a left side triangular pattern except where the opening price or value is the first extreme price or value.

13. The method of claim 12, wherein the interior of the triangular pattern is shaded or colored for indicating a direction of changes in price or value for the charted period, up or down, as determined by comparison of the closing price or value data to the opening price or value data or previous periods closing price or value data and by selecting and generating specific shades or colors to indicate a direction of price or value movement, if any, with predetermined shades or colors representing upward price or value movement, predetermined shades or colors representing downward price or value movement and predetermined shades or colors representing no overall change in price or value.

14. The method of claim 11, further comprising indicating volume of activity along with a pattern of price or value changes in the chart by performing the following steps;
defining a number and scope of volume ranges to be depicted for the charted entity,
receiving a secondary set of input data comprising market trading volume data simultaneously with the price or value data and interfaced with the same set of control data,
transforming the volume data input interfaced with the control data to calculate average volume for the charting period and categorize it by range based on defined volume ranges,
depicting the period's volume range by an increase or decrease of a length of the chart's left horizontal line, right horizontal line, or both, in increments representing specific volume ranges.

15. A method of transforming a O.H.L.C. (open, high, low, close) bar chart or a H.L.C. (high, low, close) bar chart that covers price or value changes within specific periods based on time or transaction quantities that diagrams specific intra-period price or value changes by disclosing the direction and momentum of price or value changes during an ending portion of the period, comprised of using non-transitory computer-readable media having computer-readable instructions thereon executing, by a computer the following steps;
developing a control data that identify pre-defined periods based on time or transaction quantities including period openings, intra-period closing frame segments and period closings,
receiving source of market price or value data for a charted entity,
interfacing the control data with the source of market price or value data, converting the control data and the market price or value data into charting durations thereby establishing the charting period as well as an opening price or value, if included, a closing price or value, and the charting period's intermediary price or value data including an intra-period closing frame's initial price or value,
comparing of the charting period's price or value data to establish a final highest price or value occurring during the charted period, a final lowest price or value occurring during the charted period and a range of prices or values during the charted period,
transforming of the opening price or value, if included, closing price or value and the charting period's intermediary price or value data into a chart that defines the opening price or value, if included, highest price or value, lowest price or value, initial closing frame price or value and closing price or value, and will also indicate the initial closing frame price or value so that comparison of the price or value at the beginning of the intra-period closing frame to the charting period's closing price or value provides an indication of a direction of change in price or value during the intra-period closing frame, if any, as well as the degree and speed of change occurring,
presenting a charting period's activity in a chart comprising a graph having a vertical price or value scale and composed of a vertical axis having a length, where the length and positioning in relation to the vertical price or value scale demonstrates the charting period's price or value range and a horizontal line extending leftwardly from the vertical axis demonstrating the charting period's opening price or value by its level of positioning in relation to the price or value scale (if opening price or value is to be shown) and a horizontal line extending rightwardly from the vertical axis demonstrating the charting period's closing price or value by its level of positioning in relation to the price or value scale with the chart being in black or colored to denote price or value movement, and
transforming the market price or value data to graphically illustrate an identification of the initial price or value of the pre-selected intra-period closing frame by displaying an identifying mark on or near the chart's vertical axis at a level in relation to the price or value scale that correspond to the initial price or value of the intra-period closing frame.

16. The method of claim 15, whereby a graphic display of the initial price or value of the intra-period closing frame along with the price or value movement within the closing frame is provided by;
marking the vertical axis of the chart at a price or value level occurring at the beginning of the closing frame with a diagonal line that indicates intra-period closing frame price or value movement by extending upward to the outside tip of the horizontal line representing the period's closing price or value if the level of price or value is increasing during the closing frame or by extending downward to the outside tip of the horizontal line representing the period's closing price or value if the level of price or value is decreasing during the closing frame, thus illustrating a direction, degree, and speed of changes in price or values during the pre-selected intra-period closing frame as well as creating a right side triangular pattern except where there is no net change in price or value during the closing frame.

17. The method of claim 16, wherein the interior of the triangular pattern is shaded or colored for indicating a direction of changes in price or value for the charted period, up or down, as determined by comparison of the closing price or value data to the opening price or value data or previous periods closing price or value data and by selecting and generating specific shades or colors to indicate a direction of price or value movement, if any, with predetermined shades or colors representing upward price or value movement, predetermined shades or colors representing downward price or value movement and predetermined shades or colors representing no overall change in price or value.

18. The method of claim 16, wherein the interior of the triangular pattern is shaded or colored for indicating a direction of changes in price or value up or down, during that chart period representing the closing frame determined by comparison of the initial price or value data of the pre-selected closing frame to the closing price or value data and by selecting and generating predetermined shades or colors to indicate direction of any such change with a predetermined shade or color representing upward price or value movement and another predetermined shade or color representing downward price or value movement.

19. The method of claim 15, further comprising indicating volume of activity along with a specific intra-period price or value changes in the chart by performing the following steps;
defining a number and scope of volume ranges to be depicted for the charted entity,
receiving a secondary set of input data comprising market trading volume data simultaneously with the price or value data and interfaced with the same set of control data,
transforming the volume data input interfaced with the control data to calculate average volume for the charting period and categorize it by range based on defined volume ranges,
depicting the period's volume range by an increase or decrease in the length of the opening and/or closing horizontal lines in O.H.L.C. charting or in the closing horizontal line in H.L.C. charting.

20. The method of claim 15, further comprising indicating whether average volume is increasing, decreasing, or staying steady as the charting period-closes by performing the following steps;
defining a number and scope of average volume ranges to be depicted for the charted entity,
receiving a secondary set of input data comprising market trading volume data simultaneously with the price or value data and interfaced with the same set of control data,
transforming the volume data interfaced with the control data to calculate average volume for the entire charted period and categorize it by range of volume based on defined volume ranges and also calculate average volume for the closing frame and categorize it in a same manner based upon the same volume ranges,
depicting the closing frame's volume range as compared to the entire period's volume range by increasing a length of the right horizontal closing price or value line by one increment for each additional average volume range that the closing frame exceeds that of the overall period and decreasing the length of the horizontal closing price or value line by one increment for each volume range that the closing frame's volume is lower than that of the average range for the overall period.
